(19) United States
(12) Patent Application Publication
(10) Pub. No.: US 2009/0264059 A1
(43) Pub. Date: Oct. 22, 2009

(54) Stain Applicator

(76) Inventor: William Zagone, Vancouver, WA (US)

Correspondence Address: HANCOCK HUGHEY LLP, P.O. BOX 1208, SISTERS, OR, 97759, US

(21) Appl. No.: 12/107,393

(22) Filed: Apr. 22, 2008

(51) Int. Cl. B24D 11/00; B05C 1/06

(52) U.S. Cl. 451/539; 401/17; 401/195

(57) ABSTRACT

A stain applicator and finishing pad is defined by a specialized flexible applicator pad that has on one side an absorbent applicator material that absorbs liquid stain so that the stain may be applied to a the prepared surface, and on the opposite side an abrasive coating that allows for efficient finishing of even contoured surfaces.

### FIELD OF THE INVENTION

This invention relates generally to apparatus for applying a stain to a surface, and more particularly, to a flexible stain applicator pad having a first absorbent side for applying stain to the surface and a second abrasive side for burnishing the surface.

### BACKGROUND

When a consumer decides to apply stain to either a new surface or an already-finished surface they typically visit a paint store and look at many dozens of color chips or “stain cards” and samples to get an idea of what color they want. It is well known that for a variety of reasons, stain cards do not always provide a realistic representation of how any particular color will look in the consumer's home. For example, the color represented on the card may appear different when applied to wood or some other surface in the consumer's home since the characteristics of wood—grain, texture, etc.—are always different from the material used for a color card. In addition, the finish and surface characteristics of a stain card are almost always different from the conditions found on wood in a home, and the lighting conditions in a paint store are different from the conditions found at home. As such, it is always a good idea for the consumer to test a sample of selected stains on the actual surfaces to which the stain will be applied. This is very important because only wet-applied samples of the stain applied to the raw wood product gives the consumer a representation of how the finished stain will appear.

Sometimes, the consumer takes a sample of the wood that is to be stained to the retailer so the color of the stain may be applied to the wood to give the consumer a better idea of color and luster. This requires preparing numerous samples of stain, opening the containers, applying stain to a small surface area, and waiting for the stain to dry. But even if the consumer finds a color that it appropriate at the store, the lighting conditions in the store are not the same as in the consumer's home and the selected color may look different at home than at the store.

Moreover, most consumers will have a range of colors that they want to consider and see in the actual conditions at home. But this presents several problems. First, the retailer at the paint store typically carries stains in only relatively large quantities, 1 gallon containers being the most common, with ½ pint or pint containers typically being the smallest container. When the consumer wants to test a small surface with a sample of stain, the retailer must either sell the consumer the smallest container available, or open a larger container and provide a small sample to the consumer. In the former case, the consumer ends up purchasing more stain than may be needed, especially if the consumer is testing three or four different colors. In the later case, the retailer is forced to mix several large containers of stain, open them and remove small samples to provide to the consumer. Either case is a significant problem.

Second, once the consumer has the samples at home, application of a small amount of stain to a surface can be problematic. Typically, the surface to be stained must be burnished to prepare the wood. This may be done with conventional abrasives such as sand paper, but sand paper is not effective where the surface is contoured. Moreover, conventional sand paper often leaves residue behind, which affects the appearance of the stain.

Third, once the stain is applied it is typically finished by rubbing the stained surface with a mild abrasive—typically a steel wood pad. This helps bring out a lustrous finish, but steel wool particles often detach from the pad and become embedded in the grain of the wood where the particles remain in the surface after stain has been applied. With most steel wool, the particles remaining in the wood later rust and change the color and appearance of the stain. The problem with rust does not occur with stainless steel pads, but these pads still leave particles in the stained surface and they are relatively expensive and as such not often used.

For the foregoing reasons, there is a need for a convenient method and apparatus that allows the consumer to easily and effectively test a range of stain colors at home on the actual surface. There is further a need for a convenient and effective apparatus for preparing a surface to accept stain, applying the stain and finishing the surface.

In a first embodiment, the present invention is a kit that contains plural sample aliquots of stain, typically in a spectrum of colors close to the color the consumer has in mind. As an additional embodiment, the kit contains plural specialized flexible applicator pads that have on one side an abrasive coating that allows for efficient preparation of even contoured surfaces, and on the opposite side an absorbent applicator material that quickly applies the stain to the prepared surface. The applicator pads may be provided separately for application of stain

### BRIEF DESCRIPTION OF THE DRAWINGS

The invention will be better understood and its numerous objects and advantages will be apparent by reference to the following detailed description of the invention when taken in conjunction with the following drawings.

FIG. 1 is a perspective view of a stain applicator kit according to a first illustrated embodiment of the invention, showing the various components of the kit.

FIG. 2 is a top plan view of the kit shown in FIG. 1 with the lid on the container removed.

FIG. 3 is a perspective view of the abrasive side of one applicator pad used in the stain kit of FIG. 1.

FIG. 4 is a perspective view of the applicator side of the applicator pad shown in FIG. 3.

### DETAILED DESCRIPTION OF THE PREFERRED EMBODIMENTS

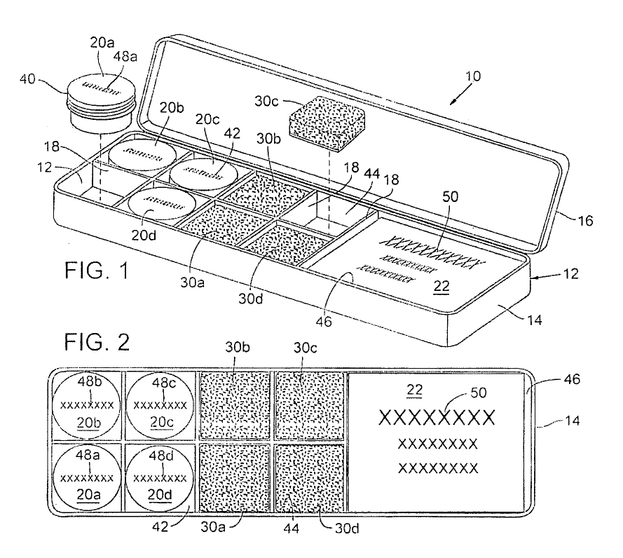

A first illustrated embodiment of a test kit 10 is shown in FIGS. 1 and 2. Test kit 10—referred to herein primarily as kit 10—includes two primary components: plural sample containers 20a, 20b, 20c and 20d, and plural applicator pads 30a, 30b, 30c and 30d. Each of the sample containers 20a through 20d contains an aliquot of stain, and typically the four containers will represent a spectrum of colors that are in the range that the consumer is interested in. Each of the components just mentioned is illustrated in a container 12 that includes a base 14 and lid 16 hinged to the base. The interior of container 12 is partitioned with dividers 18 that divide the interior into 9 separate compartments-four compartments 42 for holding the four sample containers 20, four compartments 44 for holding the four applicator pads 30, and a relatively larger compartment 46 designed to hold instructions such as pamphlet 22 and other optional items.

It will be appreciated that the container 12 shown in the figures is for illustrative purposes only—the size and shape of the container may vary widely from that shown. The container may be fabricated from plastic or other materials such as cardboard. Moreover, the number of sample containers 20 and applicator pads 30 may vary—there is no reason why the kit 10 need contain four of each. Finally, it will be understood that the kit 10 may include a different number of containers 20 from the number of applicator pads 30. Nonetheless, the preferred number of sample containers is four since it has been found that a color grouping of four colors generally gives consumers sufficient choices in a spectrum of colors to find the one particular color that meets the consumer's expectations.

The size of the compartments formed by dividers 18 conforms to the size of the sample containers 20 and the applicator pads 30 so that one container fits snugly into one compartment and one pad fits snugly into another compartment. If the relative size of the containers and pads varies, then the size of the compartments will vary accordingly. Each of the sample containers 20 and applicator pads 30 is easily removed from the container 12. The container 12 is preferably designed so that the lid 16 may be secured closed to the base. While the size of the applicator pads 30 may vary widely, one preferred size is about 1½ inches square.

In a preferred embodiment, the volume of stain contained in any single container 20 is from about ½ fluid ounce to about 3 fluid ounces, although the amount of stain may vary, the important point being that there should be enough stain that the consumer is able to get a reliable indicator of how the stain will appear on the surface that is to be treated. Each of the containers 20 preferably includes a lid 40 or other surface that may bear printed indicia 48 or a label that may be printed with indicia 48 that provides the consumer with information regarding the contents of each container. For example, the indicia 48 may include the color of the aliquot of stain held in the container, the code number for the stain, and the manufacturer of the stain. Other information may also be included, such as instructions to shake the container before use. As one example, among other indicia 48, the containers 20 may be printed with information showing the spectrum of stain colors in the containers. Thus, sample container 20a may be printed with indicia 48a indicating that the color of the stain in container 20a is “Light Walnut.” Sample container 20b could be labeled with indicia 48b, “Dark Walnut,” container 20c could be could be labeled with indicia 48c, “Red Mahogany” and 20d could be could be labeled with indicia 48d, “Dark Cherry.” Preferably, each of the containers 20 is either glass or a clear plastic so that the consumer can visually inspect the color of the stain held in the container. Similarly, the lids 40 are preferably clear so that the stain within the containers is readily visible.

As noted previously, the container 12 is divided into compartments with dividers 18. The optional compartment 46 is shown as being relatively larger than the compartments 42 and 44 and may contain a pamphlet 22 that includes information and instructions for preparation of the surface to be stained (identified as indicia 50), application of the stain, etc. Other items such as vinyl gloves (not shown), and an empty sample container may be included in compartment 46. The empty sample container is useful for the consumer to mix quantities of stain from containers 20a through 20d to arrive at a custom color blend.

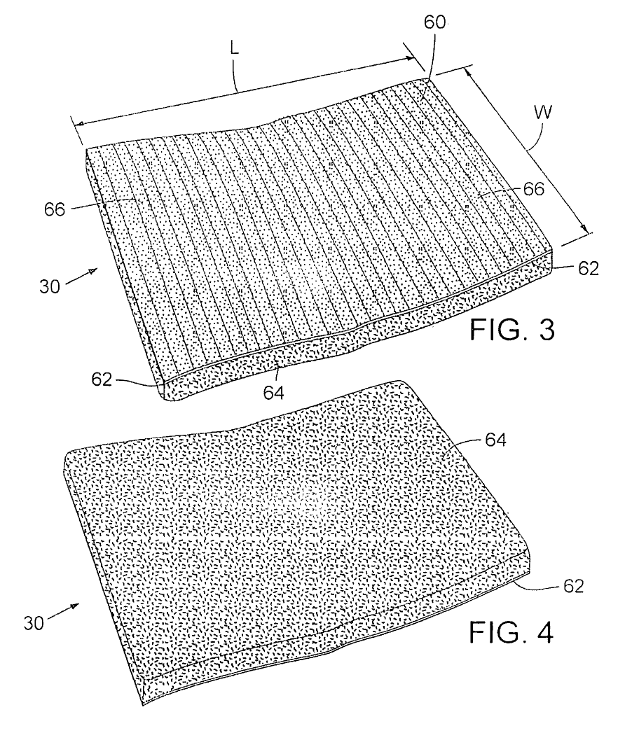

Reference now is made to FIGS. 3 and 4, which illustrate opposite sides of an applicator pad 30 as used with the present invention. The applicator pad 30 may be used either as part of the test kit 10 or as a stand-alone product that is used to apply stain to a surface and to finish the surface after the stain has been applied.

Applicator pad 30 is shown having a length L and width W, which may be any convenient dimension. As noted above, one preferred dimension for pad 30 is 1½ inches square when the pad 30 is included in test kit 10. When the pad 30 is provided as a stand-alone product, one preferred dimension is about 5 inches by 6 inches.

The pad 30 is a flexible composite sheet that in a first embodiment has three layers: an abrasive layer 60, a flexible fabric layer 62 and an absorbent applicator layer 64. In a second embodiment described below, the absorbent applicator layer 64 is omitted. Each of the layers is described below. Absorbent applicator layer 64 is preferably a soft fibrous material that readily picks up and retains liquid stain from a container 20 for application to a surface. Typically, layer 64 is a polyester fiber, although other absorbent fibers may be used. Absorbent applicator layer 64 is bound to one side of a flexible fabric layer 62, which in the preferred embodiment is a woven or mesh polyvinyl acetate fabric. The two layers just described (i.e., the flexible fabric layer 62 and absorbent applicator layer 64) are commercially available from a number of sources.

The abrasive layer 60 is formed by coating the side of polyvinyl acetate fabric 62 (or other fabric material) opposite of absorbent applicator layer 64 with non-ferrous abrasive particles 66 that have been encapsulated with a resin material that allows the abrasive particles 66 to be bonded to the fabric layer 62. The abrasive particles define an abrasive grit. In a preferred embodiment, abrasive particles 66 are stainless steel particles that are encapsulated with an acrylic resin, preferably methylmetacrylate. The encapsulated abrasive particles 66 are deposited onto the fabric layer and the coated pad 30 is heated. The heat causes the acrylic resin to bond to the fabric layer, thereby bonding the abrasive particles to the pad.

The pad 30 formed in this manner is very flexible, which allows the consumer to burnish even highly contoured surfaces very easily. Moreover, the consumer may use the same pad 30 to apply a sample of stain to the prepared surface. Because the particles 66 are stainless steel, even if particles detach from the pad 30 and become embedded in a wood surface when the wood is being abraded, the particles will not rust and change the appearance of the surface.

It will be appreciated that the abrasive layer may be formed with other coatings, including for example other non-ferrous metallic particles, ceramics, and even particles formed from various types of plastic. The size of the particles 66 may be varied to vary the amount of abrasiveness.

Pad 30 thus defines a flexible applicator that has on one side an absorbent fiber for application of the stain, and on the opposite side an abrasive surface for burnishing the stained wood to finish the stain.

The process and technique of coating abrasive particles into a pad 30 in the manner just described may be applied equally to substrate materials other than a pad 30 of the type described above. For example, non-ferrous abrasive particles 66 that have been encapsulated with resin material as described above allows the abrasive particles to be bonded to other kinds of fabric in which the abrasive particles define an abrasive grit and provide other functional and structural attributes. In an alternative embodiment, abrasive metallic or ceramic particles 66 such as those described above and which are encapsulated with an acrylic resin, preferably methylmetacrylate may be coated onto heavy fabric materials such as canvas or duck fabrics. The encapsulated abrasive particles 66 are deposited onto the fabric and the coated fabric is heated-the abrasive particles may be applied to one or both sides of the fabric substrate. The heat causes the acrylic resin to melt and thereby bond to the fabric, thereby bonding the abrasive particles to the fabric. It has been found that a applying a coating of abrasive particles to heavy fabric in the manner just described result in a fabric that is resistant to sparks and flame, even where the fabric is otherwise untreated with flame retardants and where the fabric substrate is of a type that is normally not of the kind that has good fire retardant properties, such as cotton canvas.

A flame and spark resistant fabric formed in this manner remains flexible, which allows the consumer to use the fabric as a barrier that has the ability to resist flame and sparks while reducing the risk that the fabric will ignite. It will be appreciated that the abrasive particles used to coat the fabric may include ceramics and other fire resistant materials.

The kit 10 includes samples of stain held in containers 20, and applicator pads 30, which makes it simple for the consumer to prepare the raw surface correctly and test a variety of stain colors on the surface. The paint retailer does not need to open large containers of the stain in order to provide samples to the consumer, and the consumer can evaluate stain colors in the actual physical setting where the surface is to be treated.

Typically, raw wood is first sanded or otherwise abraded in order to the prepared the raw wood to the desired smoothness. After wood dust is removed, the absorbent layer 60 of pad 30 is dipped into a sample container 20 and stain is absorbed into the pad. Stain may also be applied to the pad by spraying, rolling or brushing. The pad may then be used to apply stain to the prepared surface. Because the pads 30 are very flexible, the stain is easily applied to unevenly shaped surfaces, and contoured surfaces such as cylinders. Once the stain has been applied and has cured, the stained surface is burnished with the abrasive layer 64 of pad 30. Again owing to the flexibility of the pad, the abrasive layer facilitates burnishing of all manners of surfaces, including contoured surfaces. The burnishing step involves rubbing the stained surface with the abrasive layer 64, which brings out the lustour and sheen of the wood. The grit size that is selected will have a direct impact on the finished appearance of the wood. The abrasive particles do not become detached from the pad 30 and the wood does not have grit remaining after the surface is burnished. In one preferred manner of supplying pads 30, two pads may be packaged together and the consumer may use one pad for applying stain, and the other pad for burnishing the wood.

It will be appreciated that the invention described herein may be varied in certain ways without departing from the scope of the appended claims or their equivalents. For example, the abrasive particles could be applied to a different type of flexible pad, such as a leather pad or another flexible polyester material. In addition, the flexible abrasive pad may be a different component from the absorbent applicator pad that is used to apply stain.

While the present invention has been described in terms of a preferred embodiment, it will be appreciated by one of ordinary skill that the spirit and scope of the invention is not limited to those embodiments, but extend to the various modifications and equivalents as defined in the appended claims.

1. A flexible composite sheet comprising a sheet having an abrasive side, an absorbent side and a fabric backing layer between the abrasive side and the absorbent side.

2. The flexible composite sheet according to claim 1 wherein the abrasive side of the flexible sheet is defined by particulate material adhered to the fabric backing layer.

3. The flexible composite sheet according to claim 2 wherein the particulate matter is non-ferrous.

4. The flexible composite sheet according to claim 3 wherein the particulate material comprises stainless steel particles.

5. The flexible composite sheet according to claim 4 wherein the stainless steel particles are coated with a resin, and the particles are adhered to the backing layer of the pad by heating the particles.

6. The flexible composite sheet according to claim 3 wherein the particulate material comprises a ceramic.

7. The flexible composite sheet according to claim 2 wherein the abrasive particles are defined by non-ferrous metal particles coated with an acrylic resin.

8. The flexible composite sheet according to claim 7 wherein the acrylic resin is methylmetacrylate.

9. A flexible composite sheet comprising a fabric substrate layer having a coating of abrasive particles adhered to at least one side thereof.

10. The flexible composite sheet according to claim 9 wherein the abrasive particles are defined by non-ferrous metallic particles coated with an acrylic resin.

11. The flexible composite sheet according to claim 10 wherein the acrylic resin is methylmetacrylate.

12. The flexible composite sheet according to claim 11 in which the fabric layer comprises canvas.
